(19) United States
(12) Patent Application Publication
(10) Pub. No.: US 2011/0239441 A1
(43) Pub. Date: Oct. 6, 2011

(54) METHOD FOR MAKING STATOR

(75) Inventor: Sung-Shan HO, Taichung City (TW)

(73) Assignee: Q IN PRECISION INDUSTRIES CO., LTD., Taichung City (TW)

(21) Appl. No.: 13/040,441

(22) Filed: Mar. 4, 2011

(30) Foreign Application Priority Data
Mar. 30, 2010 (TW) 099109590

(51) Int. Cl. H02K 15/02

(52) U.S. Cl. 29/596

(57) ABSTRACT

A method for making a stator includes: (a) stacking steel sheets to form a stator core, the stator core including ribs and blocking portions; (b) preparing a mold including first and second mold parts that respectively have inner wall surfaces defining a mold cavity, the inner wall surface of each of the first and second mold parts having press blades protruding into the mold cavity; (c) positioning the stator core in the mold cavity by placing top and bottom surfaces of each of the ribs respectively in abutment with the press blades of the first and second mold parts; and (d) introducing a plastic material into the mold cavity to form a plastic insulating layer over the stator core.

### CROSS-REFERENCE TO RELATED APPLICATION

This application claims priority of Taiwanese application no. 099109590, filed on Mar. 30, 2010.

### BACKGROUND OF THE INVENTION

1. Field of the Invention

This invention relates to a method for making a stator, more particularly to a method for making a stator that includes an insulating layer having a satisfactory minimum thickness.

2. Description of the Related Art

As shown in FIGS. 3 and 4, a conventional stator 1 includes a stator core 10 and a plastic insulating layer 12. The method for making the conventional stator 1 is described as follows.

Referring to FIG. 1, a plurality of silicon steel sheets 11 are stacked and subjected to a riveting process so as to form the stator core 10. Each of the silicon steel sheets 11 has a central ring portion 111, a plurality of neck portions 112 that extend radially and outwardly from an outer periphery of the central ring portion 111 and that are angularly spaced apart from each other, and a plurality of outer blocking portions 113 that are respectively coupled to radial outer ends of the neck portions 112. The stator core 10 includes a plurality of radial ribs 15 formed by the neck portions 112 and a plurality of blocking portions 13 formed by the outer blocking portions 113.

Referring to FIG. 2, the stator core 10 is disposed in a mold cavity 20 of a mold 2. Specifically, the mold 2 includes a first mold part 21 that has an inner wall surface 211, and a second mold part 22 that has an inner wall surface 221 cooperating with the inner wall surface 211 of the first mold part 21 to define the mold cavity 20. The inner wall surface 211,221 of each of the first and second mold parts 21,22 cooperates with the stator core 10 to define a spacing region 200. The mold 2 further includes a channel 210 that is formed in the first mold part 21 and that is in spatial communication with the mold cavity 20.

A plastic material is introduced into the mold cavity 20 through the channel 210 so as to stuff the spacing regions 200. Referring to FIGS. 3 and 4, after a sufficient amount of time, the plastic insulating layer 12 is formed over the stator core 10.

The plastic insulating layer 12 includes a shell portion 121 and has a plurality of insert holes 124. The shell portion 121 covers the stator core 10, and has a plurality of first protecting fringes 122 and a plurality of second protecting fringes 123. Each of the first protecting fringes 122 is formed on a top surface of the respective one of the blocking portions 13, and each of the second protecting fringes 123 is formed on a bottom surface of the respective one of the blocking portions 13. Each of the insert holes 124 is formed in one of the first protecting fringes 122, and is adapted for insertion of a terminal 14. A minimum thickness (D1) of the plastic insulating layer 12 is larger than 0.3 mm (see FIG. 4).

However, some disadvantages of the conventional stator 1 and the method for making the same are as follows:

1. Since each of the insert holes 124 is formed in a respective one of the first protecting fringes 122, a depth of each of the insert holes 124 depends on a thickness of the respective one of the first protecting fringes 122. Generally, in order to minimize production cost and size of the stator 1, the thickness of the first protecting fringes 122 is required to be minimized. Thus, the depth of the insert holes 124 may be insufficient for fixedly retaining the terminal 14. Accordingly, operation of the stator 1 may be adversely affected since the terminal 14 may be undesirably detached from the respective one of the insert holes 124.

2. The minimum thickness (D1) of the plastic insulating layer 12 is unable to be further reduced using the aforementioned method for making the conventional stator 1. In order to form the plastic insulating layer 12 having the minimum thickness (D1) that is less than 0.3 mm, the spacing regions 200 must have a minimum dimension of less than 0.3 mm in a direction of the minimum thickness (D1) of the plastic insulating layer 12. However, reduction of the minimum dimension of the spacing regions 200 to less than 0.3 mm may give rise to an increase in flow resistance of the plastic material. Therefore, the spacing regions 200 are unable to be totally filled with the plastic material. When the plastic material is introduced into the mold cavity 20 using a higher pressure so as to overcome the flow resistance, the higher pressure may result in deformation of the ribs 15 of the stator core 10 since the ribs 15 are narrower and have a relatively weak structure compared to other portions of the stator core 10. Deformation of the ribs 15 of the stator core 10 may further change the dimension of the spacing regions 200 such that the spacing regions 200 may be incapable of being totally filled with the plastic material. As a result, a satisfactory production yield can only be achieved when the minimum dimension of the spacing regions 200 is larger than 0.3 mm. An amount of a substance (e.g., a wire) wound around the ribs 15 of the conventional stator 1 is hence limited since the minimum thickness (D1) of the plastic insulating layer 12 cannot be further reduced.

### SUMMARY OF THE INVENTION

The object of the present invention is to provide a stator that can overcome the aforesaid drawbacks of the prior art, and a method for making the same.

According to this invention, there is provided a method for making a stator. The method comprises the steps of: (a) stacking a plurality of steel sheets to form a stator core, each of the steel sheets including a central ring portion, a plurality of neck portions extending radially and outwardly from the central ring portion and angularly spaced apart from each other, and a plurality of outer blocking portions respectively coupled to radial outer ends of the neck portions, the stator core including a plurality of radial ribs formed by the neck portions and a plurality of blocking portions formed by the outer blocking portions, each of the ribs having a top surface and a bottom surface; (b) preparing a mold including a first mold part having an inner wall surface, and a second mold part having an inner wall surface cooperating with the inner wall surface of the first mold part to define a mold cavity, the inner wall surface of the first mold part having a plurality of press blades protruding into the mold cavity, the inner wall surface of the second mold part having a plurality of press blades protruding into the mold cavity; (c) positioning the stator core in the mold cavity by placing the top and bottom surfaces of each of the ribs respectively in abutment with the press blades of the first mold part and the second mold part; and (d) introducing a plastic material into the mold cavity to form a plastic insulating layer over the stator core.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a perspective view of a stator core of a conventional stator;

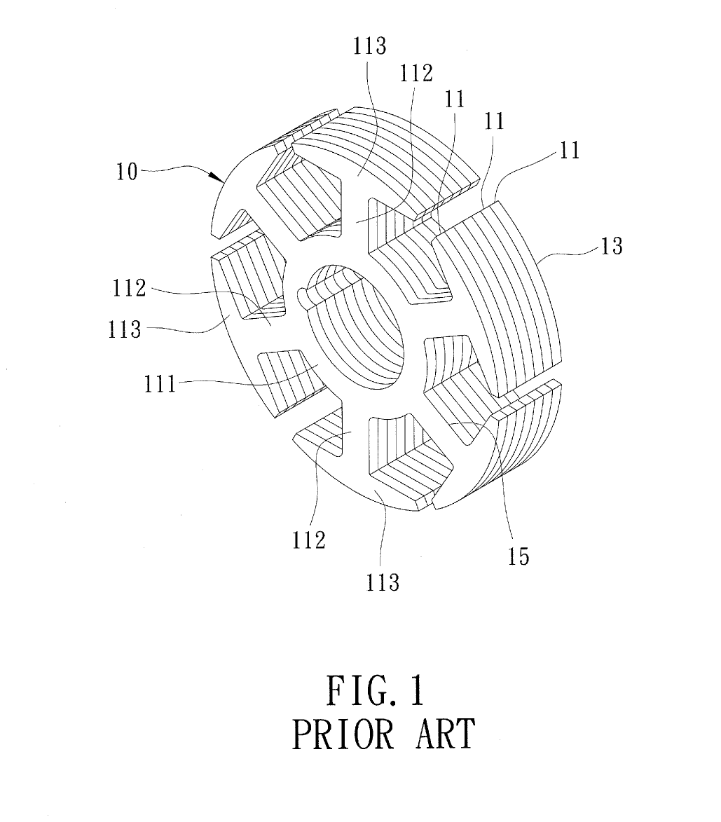

FIG. 2 is a schematic sectional view illustrating that the stator core is disposed in a mold cavity of a mold used in a method for making the conventional stator;

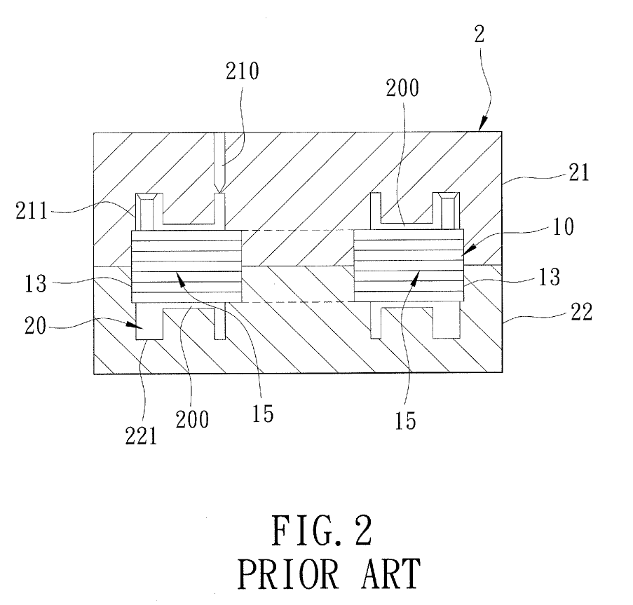

FIG. 3 is a schematic top view of the conventional stator;

FIG. 4 is a schematic sectional view taken along line IV-IV in FIG. 3;

FIG. 5 is a perspective view to illustrate a stator core of the preferred embodiment of a stator according to this invention;

FIG. 6 is a schematic sectional view illustrating that the stator core is positioned in a mold cavity of a mold used in the preferred embodiment of a method for making the stator of this invention;

FIG. 7 is a schematic top view of the preferred embodiment of the stator; and

FIG. 8 is a schematic sectional view taken along line VIII-VIII in FIG. 7.

### DETAILED DESCRIPTION OF THE PREFERRED EMBODIMENTS

The preferred embodiment of a method for making a stator according to the present invention is described as follows.

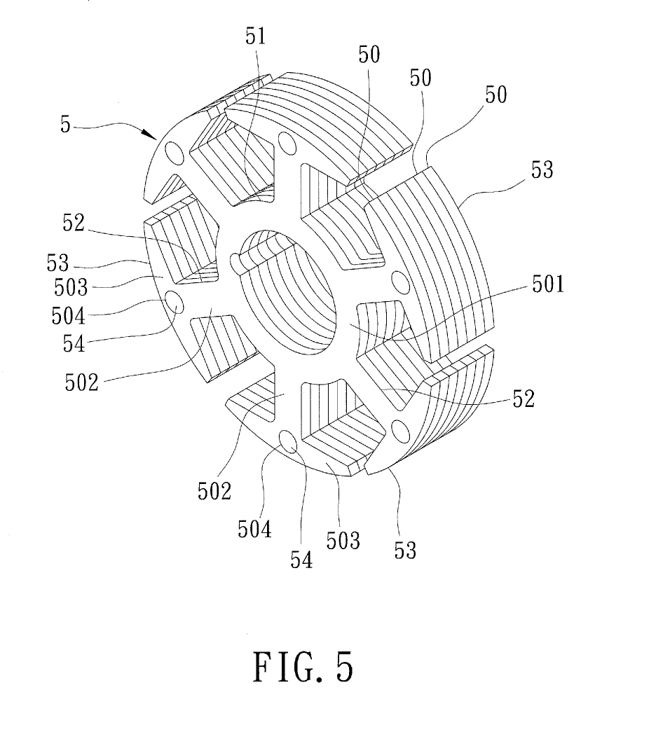

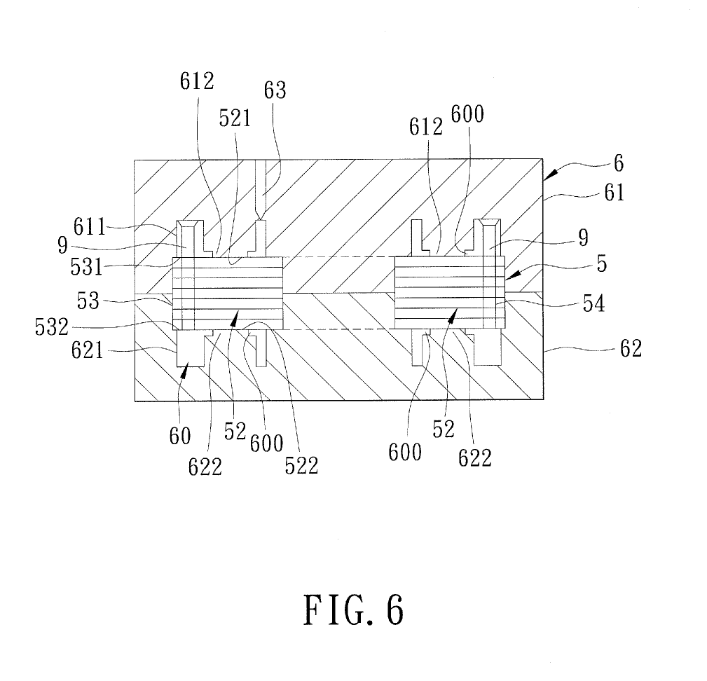

Referring to FIG. 5, a plurality of steel sheets 50 are stacked to form a stator core 5. In this embodiment, the steel sheets 50 are silicon steel sheets. Each of the steel sheets 50 includes a central ring portion 501, a plurality of neck portions 502 that extend radially and outwardly from an outer periphery of the central ring portion 501 and that are angularly spaced apart from each other, and a plurality of outer blocking portions 503 that are respectively coupled to radial outer ends of the neck portions 502. The stator core 5 includes a ring yoke 51 that is formed by the central ring portions 501, a plurality of radial ribs 52 that are formed by the neck portions 502, and a plurality of blocking portions 53 that are formed by the outer blocking portions 503. Each of the ribs 52 has a top surface 521 and a bottom surface 522, as best shown in FIG. 6.

In this embodiment, a through hole 504 is provided in each of the outer blocking portions 503 of the steel sheets 50 so that each of the blocking portions 53 of the stator core 5 has an insert hole 54 formed by a stack of the through holes 504 provided respectively in the corresponding outer blocking portions 503 which are aligned with each other.

Referring to FIG. 6, a mold 6 is prepared, and includes a first mold part 61 that has an inner wall surface 611, and a second mold part 62 that has an inner wall surface 621 cooperating with the inner wall surface 611 of the first mold part 61 to define a mold cavity 60. The inner wall surface 611 of the first mold part 61 has a plurality of press blades 612 protruding into the mold cavity 60. The inner wall surface 621 of the second mold part 62 has a plurality of press blades 622 protruding into the mold cavity 60. In this embodiment, a channel 63 is formed in the first mold part 61 and is in spatial communication with the mold cavity 60. It should be noted that the channel 63 could be formed in the second mold part 62 in other embodiments.

The stator core 5 is positioned in the mold cavity 60 by placing the top and bottom surfaces 521,522 of each of the ribs 52 respectively in abutment with the press blades 612,622 of the first and second mold parts 61,62. Since the inner wall surfaces 611,621 of the first and second mold parts 61,62 only partially contact the stator core 5, a spacing region 600 exists between the inner wall surface 611,621 of each of the first and second mold parts 61,62 and the stator core 5.

A detailed way to position the stator core 5 in the mold cavity 60 of the mold 6 is described as follows. First, the stator core 5 is positioned in the second mold part 62 by placing the bottom surface 522 of each of the ribs 52 in abutment with a respective one of the press blades 622 of the second mold part 62. Subsequently, a positioning pin 9 is inserted into the insert hole 54 in a respective one of the blocking portions 53. The first mold part 61 is then stacked on the second mold part 62 so that the top surface 521 of each of the ribs 52 is in abutment with a respective one of the press blades 612 of the first mold part 61. A top end of each of the positioning pins 9 is disposed in abutment with the inner wall surface 611 of the first mold part 61.

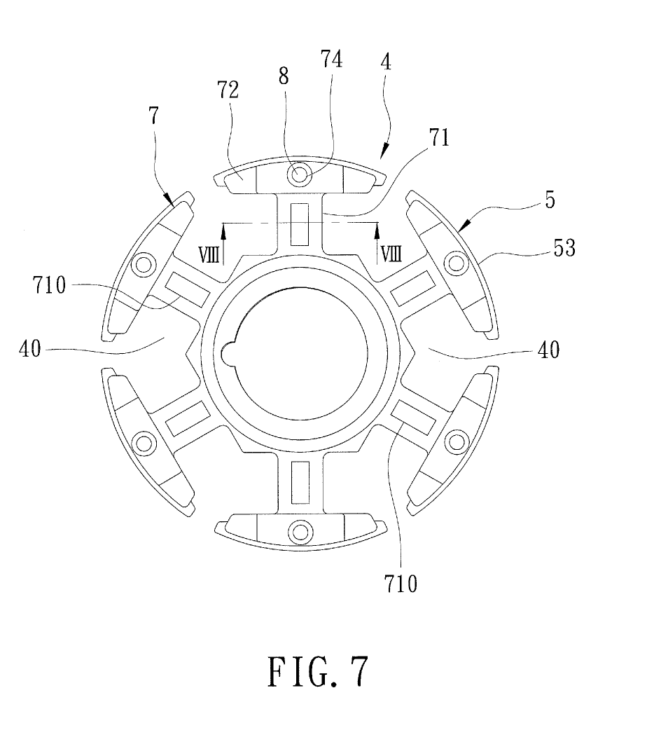

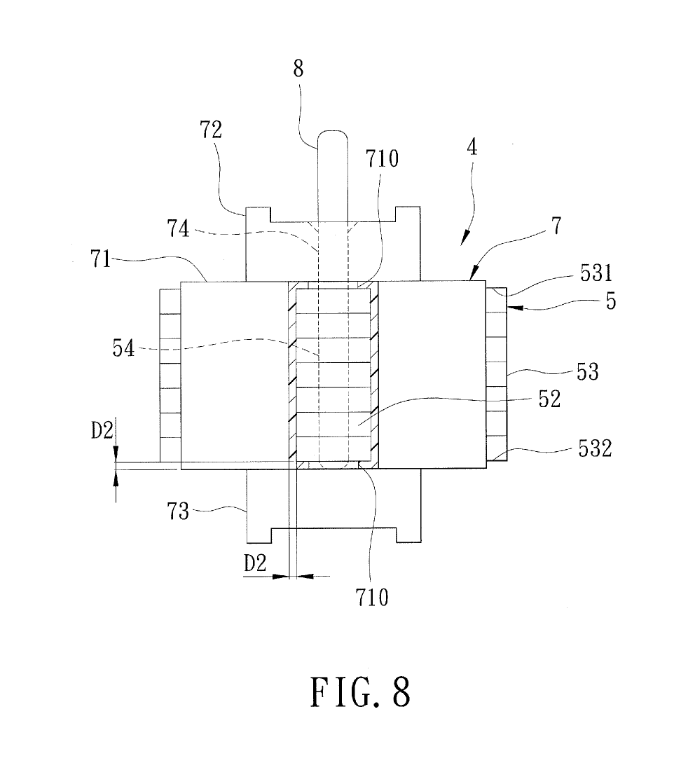

A plastic material is introduced into the mold cavity 60 of the mold 6 through the channel 63 so as to stuff the spacing regions 600. Referring to FIGS. 7 and 8, after a sufficient amount of time, a plastic insulating layer 7 is formed over the stator core 5. The plastic insulating layer 7 has a shape corresponding to those of the spacing regions 600 (see FIG. 6), and hence includes a shell portion 71 that covers the stator core 5. Since portions of the plastic material are formed around the positioning pins 9, the plastic insulating layer 7 has a plurality of insert holes 74, each of which is in alignment with and in spatial communication with the insert hole 54 of the respective one of the blocking portions 53 of the stator core 5.

The shell portion 71 has a plurality of first protecting fringes 72 and a plurality of second protecting fringes 73. Each of the first protecting fringes 72 is formed on a top surface 531 of the respective one of the blocking portions 53. Each of the second protecting fringes 73 is formed on a bottom surface 532 of the respective one of the blocking portions 53. Each of the insert holes 74 of the plastic insulating layer 7 is formed in a respective one of the first protecting fringes 72. Consequently, a terminal 8 may be inserted into the insert hole 74 of the respective one of the first protecting fringes 72 and the insert hole 54 of the respective one of the blocking portions 53. The insert hole 74 of the respective one of the first protecting fringes 72 and the insert hole 54 of the respective one of the blocking portions 53 can cooperate to securely retain the terminal 8 since the insert holes 74, 54 can retain a major part of the terminal 8. Nevertheless, it should be noted that in order to minimize a size of the stator 4, the first protecting fringes 72 could be formed to have a smaller thickness, or the stator 4 could be made without forming the first protecting fringes 72 on the stator core 5 thereof. The insert hole 54 of the respective one of the blocking portions 53 is capable of solely fixedly retaining the terminal 8. Thus, stable operation of the stator 4 of this invention may be ensured.

Since end portions of the press blades 612,622 of the first and second mold parts 61,62 abut against the ribs 52 during formation of the plastic insulating layer 7, the plastic insulating layer 7 thus formed has a plurality of openings 710 that have shapes corresponding to those of the end portions of the press blades 612,622. Each of the openings 710 exposes a portion of a respective one of the ribs 52.

Even though the ribs 52 of the stator core 5 have a relatively weak structure compared to other portions of the stator core 5, the press blades 612,622 of the first and second mold parts 61,62 are capable of fixing the ribs 52 of the stator core 5 so as to prevent the same from deformation when a higher pressure is applied. Therefore, a dimension of the spacing regions 600 is maintained, and the spacing regions 600 may be totally filled with the plastic material. As a result, the plastic insulating layer 7 may uniformly cover the stator core 5. The method of this invention may be conducted to produce the stator 4 having a stable structure and a satisfactory quality.

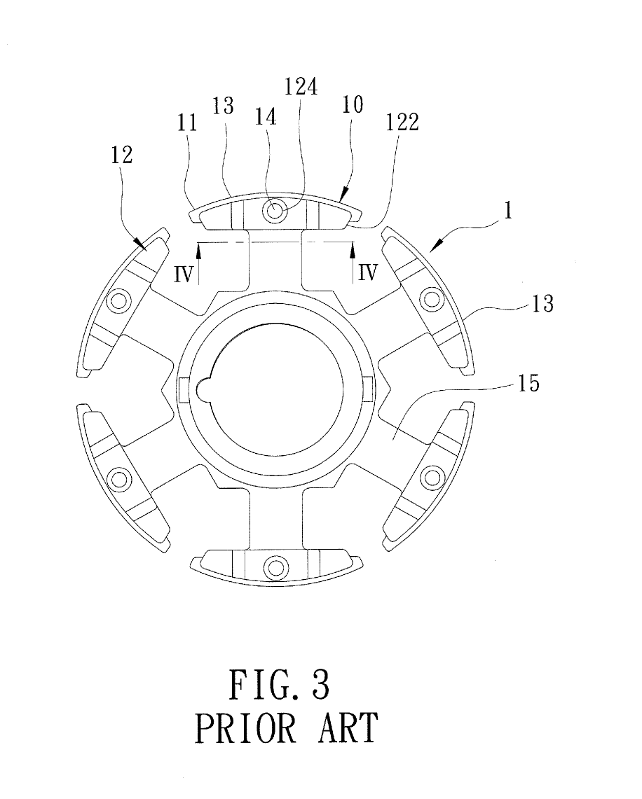

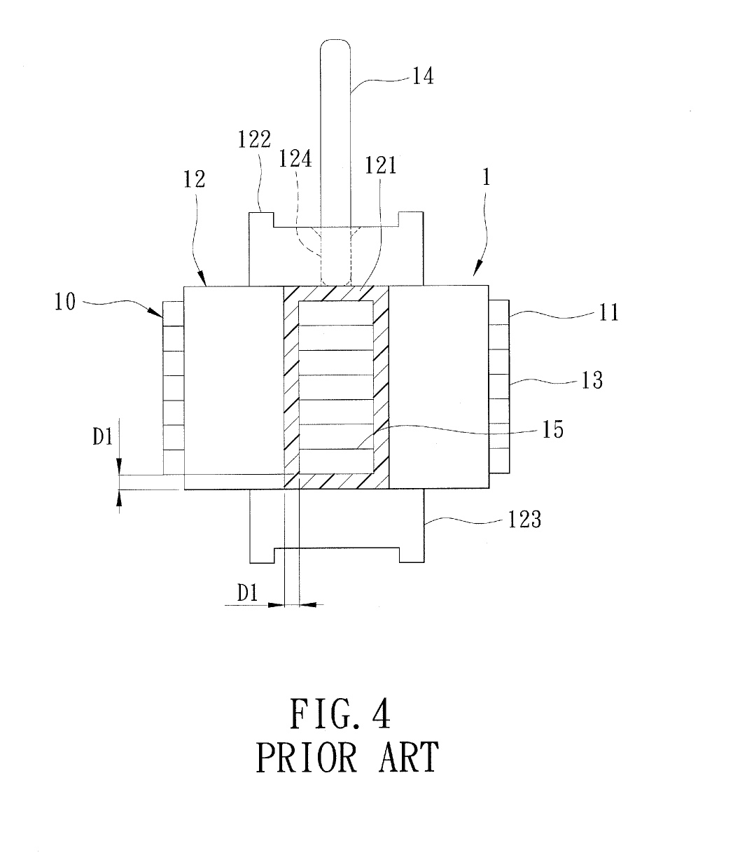

A minimum thickness (D2) of the plastic insulating layer 7 depends on a minimum dimension of the spacing regions 600. When the spacing regions 600 have the minimum dimension of less than 0.3 mm in a direction of the minimum thickness (D2) of the plastic insulating layer 7, the plastic insulating layer 7 has the minimum thickness (D2) of less than 0.3 mm. Similarly, when the spacing regions 600 have the minimum dimension of less than 0.15 mm in a direction of the minimum thickness (D2) of the plastic insulating layer 7, the plastic insulating layer 7 has the minimum thickness (D2) of less than 0.15 mm. By virtue of the press blades 612,622 capable of preventing the ribs 52 from deformation, the spacing regions 600 are suitable to have the minimum dimension of less than 0.3 mm under the higher pressure, or are even suitable to have the minimum dimension of less than 0.15 mm under the higher pressure. Thus, the minimum thickness (D2) of the plastic insulating layer 7 of the stator 4 of this invention is smaller than that of the plastic insulating layer 12 of the conventional stator 1 shown in FIGS. 3 and 4.

Accordingly, accommodating spaces 40 (see FIG. 7) for windings of a substance are larger. Specifically, an amount of the substance (e.g., an enamel wire) wound around the respective one of the ribs 52 of the stator 4 of this invention is increased compared to the conventional stator 1. An efficiency of the stator 4 of this invention may be hence enhanced. Moreover, the size of the stator 4 of this invention is smaller than that of the conventional stator 1 due to the smaller minimum thickness (D2) of the plastic insulating layer 7.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for making a stator, comprising the steps of:
(a) stacking a plurality of steel sheets to form a stator core, each of the steel sheets including a central ring portion, a plurality of neck portions extending radially and outwardly from the central ring portion and angularly spaced apart from each other, and a plurality of outer blocking portions respectively coupled to radial outer ends of the neck portions, the stator core including a plurality of radial ribs formed by the neck portions and a plurality of blocking portions formed by the outer blocking portions, each of the ribs having a top surface and a bottom surface;
(b) preparing a mold including a first mold part having an inner wall surface, and a second mold part having an inner wall surface cooperating with the inner wall surface of the first mold part to define a mold cavity, the inner wall surface of the first mold part having a plurality of press blades protruding into the mold cavity, the inner wall surface of the second mold part having a plurality of press blades protruding into the mold cavity;
(c) positioning the stator core in the mold cavity by placing the top and bottom surfaces of each of the ribs respectively in abutment with the press blades of the first mold part and the second mold part; and
(d) introducing a plastic material into the mold cavity to form a plastic insulating layer over the stator core.

2. The method as claimed in claim 1, wherein the plastic insulating layer is formed in a spacing region between the inner wall surface of each of the first and second mold parts and the stator core, the spacing region having a minimum dimension of less than 0.3 mm in a direction of a minimum thickness of the plastic insulating layer so that the plastic insulating layer has the minimum thickness of less than 0.3 mm.

3. The method as claimed in claim 2, wherein the minimum thickness of the plastic insulating layer is less than 0.15 mm.

4. The method as claimed in claim 1, further comprising: providing a through hole in each of the outer blocking portions of the steel sheets so that each of the blocking portions of the stator core has an insert hole formed by a stack of the through holes provided respectively in the corresponding outer blocking portions that are aligned with each other; and inserting a positioning pin into the insert hole in each of the blocking portions, wherein the plastic material is formed around the positioning pins so that the plastic insulating layer has insert holes respectively aligned with the insert holes in the blocking portions.
